(19) United States
(12) Patent Application Publication
(10) Pub. No.: US 2026/0159301 A1
(43) Pub. Date: Jun. 11, 2026

(54) Double-Layer Hollow Plate Structure

(71) Applicant: NINGBO ANSOL CABINET CO., LTD., Ningbo (CN)

(72) Inventor: Limin Yuan, Ningbo (CN)

(21) Appl. No.: 19/079,988

(22) Filed: Mar. 14, 2025

(30) Foreign Application Priority Data
Dec. 11, 2024 (CN) 2024118156376

(51) Int. Cl. B65D 81/05

(52) U.S. Cl. CPC B65D 81/052

(57) ABSTRACT

A double-layer hollow plate structure, comprising a hollow plate, wherein the hollow plate is a double-layer wall structure and a cavity is provided between the double-layer walls; both side walls of the hollow plate are regularly provided with a plurality of corresponding crisscrossed grooves in units, and each groove is gradually deepened in an arc shape in the depth direction until it is connected with the corresponding groove on the opposite side at the intersection. The arc-shaped grooves in the depth direction that are crisscrossed and distributed have a reinforcing effect on the wall surface. The grooves on the two side walls are connected together at the corresponding intersections to support the two walls. Many intersections of the grooves on the two side walls are connected into many supporting points to support the entire two wall surfaces, so that the grooves on the two wall surfaces can be strengthened.

### TECHNICAL FIELD

The invention relates to the technical field of packaging materials, in particular to a double-layer hollow plate structure.

### BACKGROUND ART

When transporting household appliances such as refrigerators, washing machines, air conditioners, range hoods, and furniture and cabinets, they are usually protected by foam boards, pearl cotton boards, honeycomb paperboards, and corrugated paperboards to prevent damage during transportation and handling. However, foam boards, pearl cotton boards, honeycomb paperboards, and corrugated paperboards still have the following serious defects when used:
foam board is not environmentally friendly and is brittle, and is easy to break during use; pearl cotton board has low strength and cannot bear heavy weight; honeycomb cardboard is easily crushed and not waterproof; corrugated cardboard consumes a large number of trees, has a complicated processing process, produces a large amount of wastewater that pollutes the environment, and is not waterproof.

### SUMMARY OF THE INVENTION

In order to achieve the above purpose, the invention provides the following technical solutions: a double-layer hollow plate structure, comprising a hollow plate, wherein the hollow plate is a double-layer wall structure and a cavity is provided between the double-layer walls; both side walls of the hollow plate are provided with a plurality of crisscrossed grooves, and the grooves deepen towards an inside of the cavity to form an arch shape.

Preferably, the positions of the grooves on both sides of the hollow plate correspond to each other.

Preferably, a plurality of crisscrossed grooves form a grid shape.

Preferably, the arch-shaped groove is recessed into the cavity to the deepest at the vertical and horizontal intersection point.

Preferably, the arch-shaped grooves on both sides of the hollow plate gradually deepen towards the vertical and horizontal intersection points and towards the inside of the cavity until they intersect and connect together at the vertical and horizontal intersection points.

Preferably, the crisscrossed grooves divide the two side walls of the hollow plate into a plurality of unit areas.

Preferably, the unit areas are in the shape of one of square, circle, triangle, rhombus, polygon, and line, or a combination of two or more.

Preferably, the grid reinforcement formed by a plurality of crisscrossed grooves may also be replaced by a plurality of blind hole grooves.

Preferably, the depth of the arch-shaped groove recessed into the cavity is one of greater than zero, equal to zero, or less than zero.

Compared with the prior art, the invention provides a double-layer hollow plate structure, which has the following beneficial effects.

In the double-layer hollow board structure, the arc-shaped grooves in the depth direction that are crisscrossed and distributed have a reinforcing effect on the wall surface. The grooves on the two side walls are connected together at the corresponding intersections to support the two walls. Many intersections of the grooves on the two side walls are connected into many supporting points to support the entire two wall surfaces, so that the grooves on the two wall surfaces can be strengthened. The two wall surfaces are supported by many supporting points. The board with a hollow interior has strong cushioning performance and strength, and its strength can be adjusted by adjusting the wall thickness. It can replace foam boards, pearl cotton boards, honeycomb paperboards, and corrugated paperboards, and has broad application prospects.

### BRIEF DESCRIPTION OF THE DRAWINGS

The drawings, which constitute part of the specification, illustrate embodiments of the invention and, together with the description, further serve to explain the principles of the invention and enable those skilled in the relevant art to make and use the invention:

FIG. 1 is a schematic structural diagram of the double-layer hollow plate structure according to the invention;

FIG. 2 is a structural front view of the double-layer hollow plate structure according to the invention;

FIG. 3 is a structural cross-sectional view of the unit areas in the double-layer hollow plate structure according to the invention;

FIG. 4 is a structural cross-sectional view of the grooves in the double-layer hollow plate structure according to the invention;

FIG. 5 is a structural cross-sectional view of the hollow plate in the double-layer hollow plate structure according to the invention;

FIG. 6 is a schematic diagram of the double-layer hollow plate structure according to the invention, in which the unit area is surrounded by grooves to form circles;

FIG. 7 is a schematic diagram of the double-layer hollow plate structure according to the invention, in which the unit area is surrounded by grooves to form honeycomb shapes;

FIG. 8 is a schematic structural diagram of Embodiment 2 in the double-layer hollow plate structure according to the invention;

FIG. 9 is a schematic side view of Embodiment 2 in the double-layer hollow plate structure according to the invention;

FIG. 10 is a structural cross-sectional view of the cavity in Embodiment 2 in the double-layer hollow plate structure according to the invention;

FIG. 11 is a schematic structural diagram of the unit area in Embodiment 2 in the double-layer hollow plate structure according to the invention;

FIG. 12 is a structural cross-sectional view of the groove in Embodiment 2 in the double-layer hollow plate structure according to the invention;

FIG. 13 is a structural cross-sectional view of the unit area in Embodiment 2 in the double-layer hollow plate structure according to the invention;

FIG. 14 is a schematic structural diagram of Embodiment 3 in the double-layer hollow plate structure according to the invention;

FIG. 15 is a rear view of Embodiment 3 in the double-layer hollow plate structure according to the invention;

FIG. 16 is a schematic structural diagram of the groove in Embodiment 3 in the double-layer hollow plate structure according to the invention;

FIG. 17 is a structural cross-sectional view of the unit area in Embodiment 3 in the double-layer hollow plate structure according to the invention;

FIG. 18 is a structural cross-sectional view of the groove in Embodiment 3 in the double-layer hollow plate structure according to the invention;

FIG. 19 is a structural cross-sectional view of the cavity in Embodiment 3 in the double-layer hollow plate structure according to the invention.

In the figures: 1 refers to the hollow plate; 11 refers to the cavity; 12 refers to the groove; 13 refers to the unit area.

As shown in the figures, in order to clearly implement the structure of the embodiment of the invention, specific structures and devices are marked in the figures, but this is only for illustrative purposes and is not intended to limit the invention to the specific structure, device and environment. According to specific needs, those of ordinary skill in the art can adjust or modify these devices and environments, and the adjustments or modifications made are still included in the scope of the attached claims.

### SPECIFIC EMBODIMENT OF THE INVENTION

The technical solutions in the embodiments of the invention will be clearly and completely described hereinafter with reference to the drawings in the embodiments of the invention. Obviously, the described embodiments are only a part of the embodiments of the invention, rather than all the embodiments. Based on the embodiments of the invention, all other embodiments obtained by those of ordinary skill in the art without creative efforts shall fall within the protection scope of the invention.

### Embodiment 1

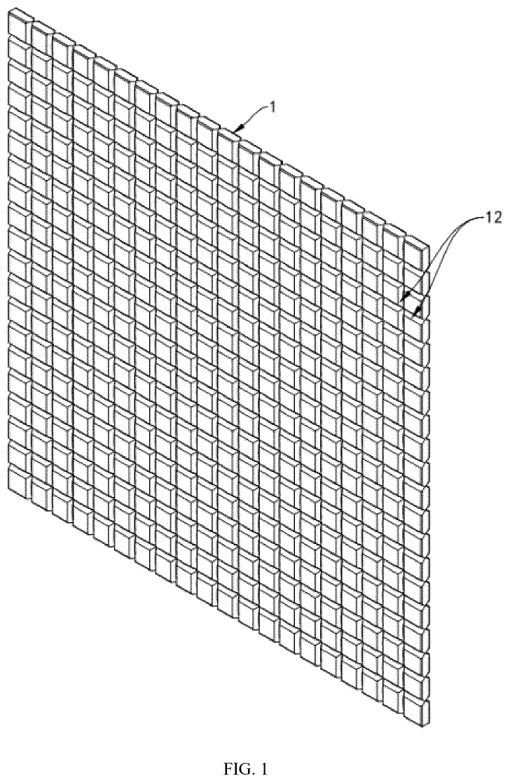

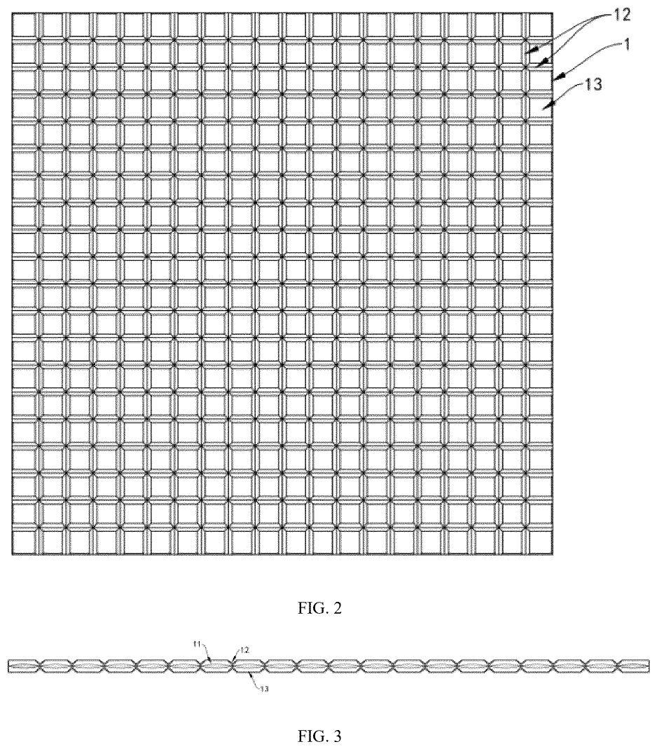

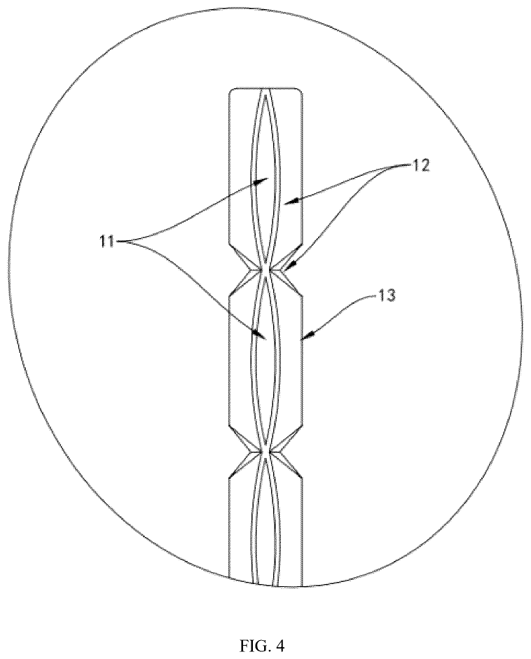

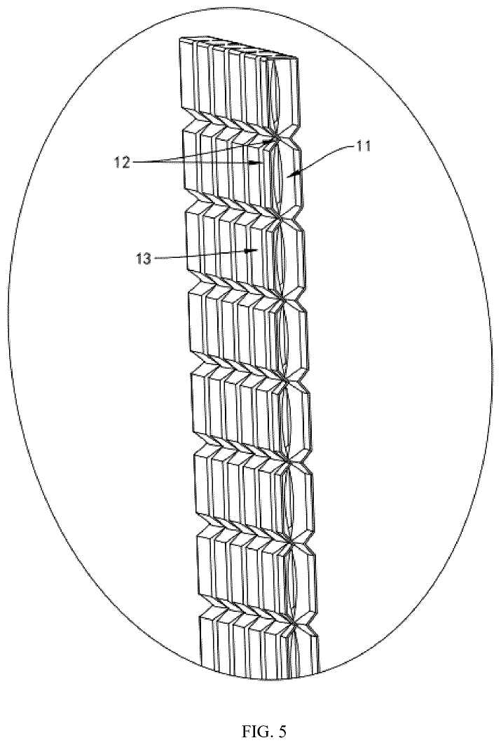

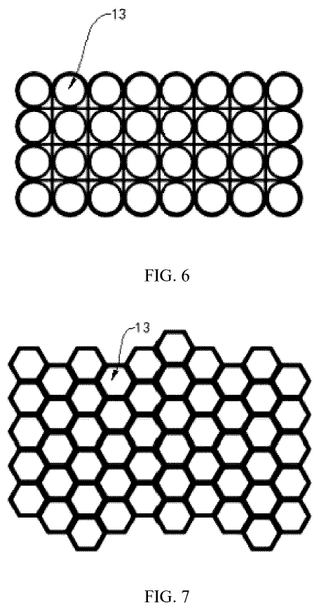

With reference to FIGS. 1-7, a double-layer hollow plate structure, comprising a hollow plate 1, wherein the hollow plate 1 is a double-layer wall structure and a cavity 11 is provided between the double-layer walls; both side walls of the hollow plate 1 are provided with a plurality of crisscrossed grooves 12, and the grooves 12 deepen towards an inside of the cavity 11 to form an arch shape.

As a specific technical solution of the embodiment, the positions of the grooves 12 on both sides of the hollow plate 1 correspond to each other. The positions of the grooves 12 on the inner and outer walls of the hollow plate 1 correspond to each other. The depression of the grooves 12 makes the distance there the shortest. During blow molding, the wall thickness is thick at the place with a short distance, so that the wall thickness at the grooves 12 is the thickest and the strength is the strongest, just like a layer of staggered support skeleton connected together in a double-layer plate. When the wall is extruded, the contact distance between the inner and outer wall grooves 12 is the shortest, thereby generating the shortest impedance time and the strongest impedance to the impact of external force. Moreover, this corresponding distribution is easy to process and beautiful, which brings convenience to subsequent processing and use.

As a specific technical solution of the embodiment, a plurality of crisscrossed grooves 12 form a grid shape. The grooves 12 are interwoven into a network, dividing the entire large area of the wall into numerous small units, thereby greatly increasing the wall strength. In this way, the wall thickness can be greatly reduced to achieve the required strength, thereby greatly reducing materials, reducing weight, saving material costs, and saving transportation costs.

As a specific technical solution of the embodiment, the arch-shaped groove 12 is recessed into the cavity 11 to the deepest at the vertical and horizontal intersection point, and the arch-shaped grooves 12 on both sides of the hollow plate 1 gradually deepen towards the vertical and horizontal intersection points and towards the inside of the cavity 11 until they intersect and connect together at the vertical and horizontal intersection points. The groove 12 is wavy or arched in the depth direction, and this structure is just like the principle of an arch bridge. When the wall is impacted by external force, the arched groove 12 can transmit the external force to the support point, thereby achieving a good shock absorption effect. At the same time, the arched groove 12 makes the inner and outer walls not connected together except at the intersection, so that the blowing gas can pass through, thereby ensuring that the hollow plate 1 can be blow-molded, and ensuring that the inner and outer walls are not bonded together, which greatly increases the strength and improves the molding performance. The inner and outer walls are connected together at the intersection of the groove 12, which can play the role of supporting points for the inner and outer walls. The intersections of the numerous inner and outer wall grooves 12 are connected into numerous supporting points to support the entire two wall surfaces, so that the inner and outer walls are supported and strengthened, thereby achieving the required strength. This structure can further reduce the wall thickness, save materials, and reduce weight.

As a specific technical solution of the embodiment, the crisscrossed grooves 12 divide the two side walls of the hollow plate 1 into a plurality of unit areas 13, and the unit areas 13 are in the shape of one of square, circle, triangle, rhombus, polygon, and line, or a combination of two or more. One or a combination of two or more of square, circular, triangular, rhombus, polygonal and linear shapes may also be arranged in the plane of the unit area 13 surrounded by the grooves 12. Different patterns of the grooves 12 will produce different distributions of the grooves 12, so that the density of the grooves 12 and the arrangement direction of the grooves 12 are changed to cope with different usage scenarios. For example, when the hollow plate 1 needs to be bent, a linear pattern groove 12 can be used. If better surface strength is required, it can be arranged into a regular hexagonal honeycomb curve that is not easy to bend, etc. Different patterns can be arranged in the plane of the unit area 13 surrounded by the grooves 12, and the plane can be strengthened or decorated.

As a specific technical solution of the embodiment, the hollow plate 1 is made of PP, PE or nylon, etc. Plastics such as PP, PE, nylon or other materials with the same effect and easy to blow mold are used for blow molding. The feed port mold adopts a wall thickness controller to control the uniform wall thickness. Large-scale blow molding equipment (length and width can reach several meters) is used to blow mold a double-layer hollow structural plate with uniform wall thickness of commonly used specifications and sizes.

As a specific technical solution of the embodiment, the hollow plate 1 is formed by blow molding or rotational molding. By adjusting the blow molding die and controlling the wall thickness of the wall thickness controller, hollow plates 1 with various wall thicknesses and strengths can be obtained without reopening the mold or changing the blow molding mold to cope with scenarios with different strength requirements, which greatly simplifies the processing tooling equipment and the processing process and has great economic benefits. During the rotational molding process, plastic particles are first put into the mold cavity of the rotational molding machine, and the plastic particles are gradually melted, thinned and attached to the mold cavity through heating, rotation, pressurized blowing and stretching processes, and a hollow plate 1 is formed after cooling. Rotational molding can produce large-sized hollow plates 1, which can supplement large-sized processing that cannot be completed by blow molding.

As a specific technical solution of the embodiment, the grid reinforcement formed by a plurality of crisscrossed grooves 12 may also be replaced by a plurality of blind hole grooves.

As a specific technical solution of the embodiment, the depth of the arch-shaped groove 12 recessed into the cavity 11 is one of greater than zero, equal to zero, or less than zero. Some grooves can be selectively deepened or shallower or cancelled, and the strength and cushioning performance of the hollow plate can be adjusted to meet different application requirements of the softness and strength of the hollow plate.

### Embodiment 2

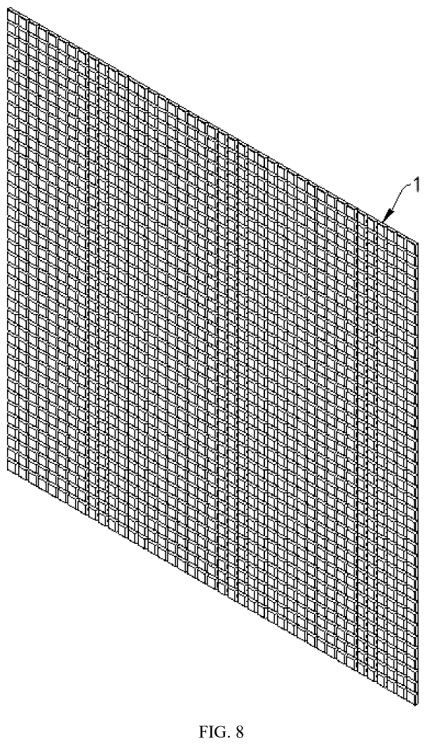

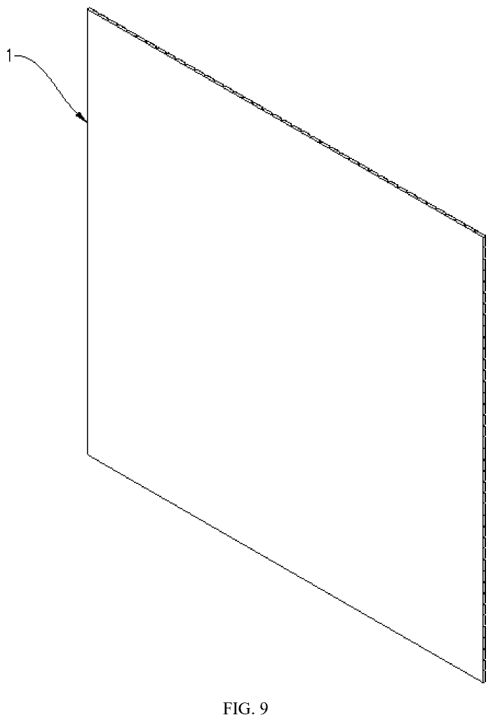

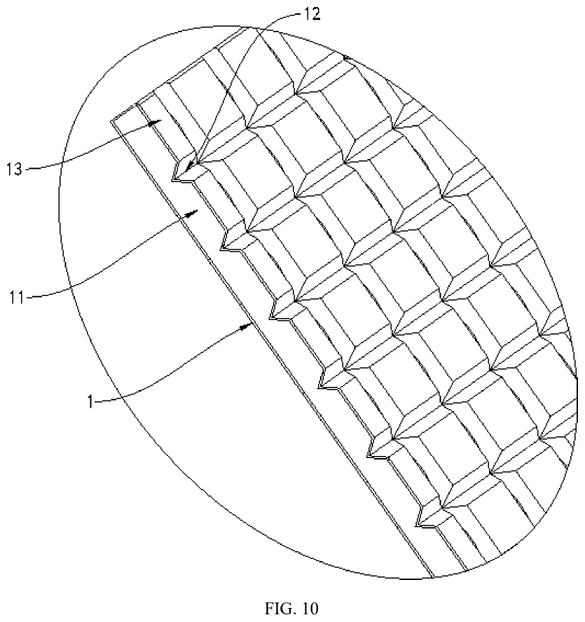

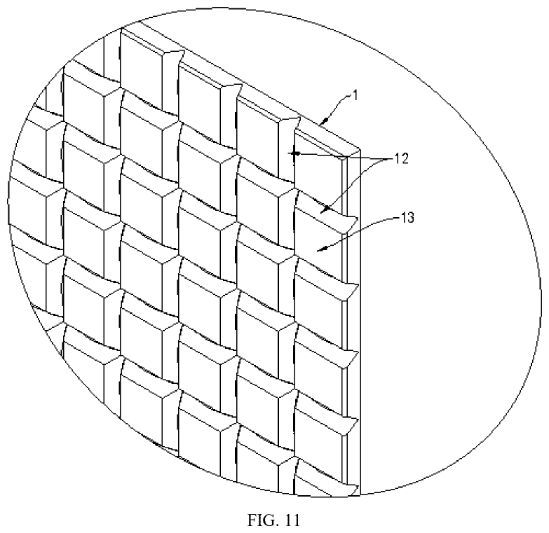

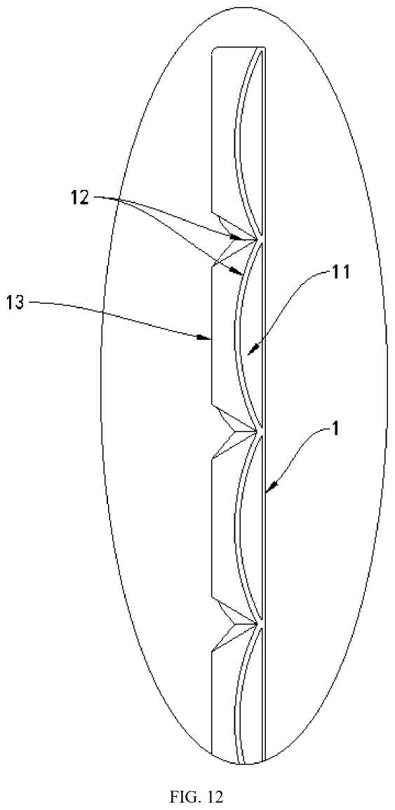

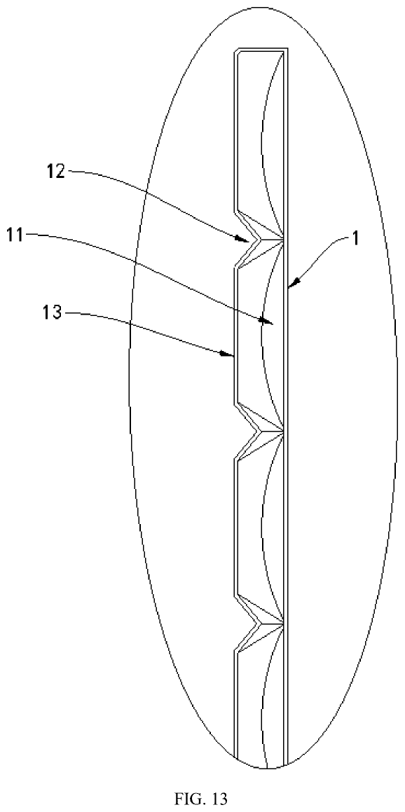

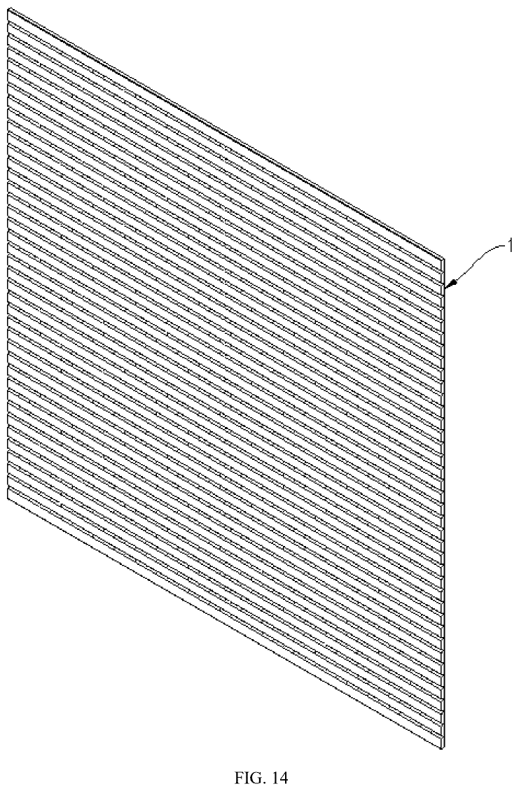

With reference to FIGS. 8-13, a double-layer hollow plate structure, comprising a hollow plate 1, wherein the hollow plate 1 is a double-layer wall structure and a cavity 11 is provided between the double-layer walls; both side walls of the hollow plate 1 are provided with a plurality of crisscrossed grooves 12, and the grooves 12 deepen towards an inside of the cavity 11 to form an arch shape.

As a specific technical solution of the embodiment, a plurality of crisscrossed grooves 12 form a grid shape.

In the embodiment, the grooves 12 are interwoven into a network, dividing the entire large area of the wall into numerous small units, thereby greatly increasing the wall strength. In this way, the wall thickness can be greatly reduced to achieve the required strength, thereby greatly reducing materials, reducing weight, saving material costs, and saving transportation costs.

As a specific technical solution of the embodiment, the arch-shaped groove 12 is recessed into the cavity 11 to the deepest at the vertical and horizontal intersection point.

As a specific technical solution of the embodiment, the arch-shaped groove 12 on one side of the hollow plate 1 gradually deepens towards the vertical and horizontal intersection points towards the inside of the cavity 11 until it contacts and connects with the other side wall of the hollow plate 1.

In the embodiment, the groove 12 is arched in the depth direction, and this structure is just like the principle of an arch bridge. When the wall is impacted by external force, the arched groove 12 can transmit the external force to the support point, thereby achieving a good shock absorption effect. The two side walls are connected together at the intersection of the groove 12, which can play a role of support points of the two side walls. The intersections of many grooves 12 on the two side walls are connected into many support points to support the entire two wall surfaces, so that the support between the two side walls is strengthened, thereby achieving the required strength. This structure can further reduce the wall thickness, save materials, and reduce weight.

As a specific technical solution of the embodiment, the crisscrossed grooves 12 divide the two side walls of the hollow plate 1 into a plurality of unit areas 13.

As a specific technical solution of the embodiment, the unit areas 13 are in the shape of one of square, circle, triangle, rhombus, polygon, and line, or a combination of two or more.

In the embodiment, Different patterns of the grooves 12 will produce different distributions of the grooves 12, so that the density of the grooves 12 and the arrangement direction of the grooves 12 are changed to cope with different usage scenarios. For example, when the hollow plate 1 needs to be bent, a linear pattern groove 12 can be used. If better surface strength is required, it can be arranged into a regular hexagonal honeycomb curve that is not easy to bend, etc. Different patterns are arranged in the plane of the unit area 13 surrounded by the grooves 12, so that the plane can be strengthened or decorated. The hollow plate 1 is formed by blow molding or rotational molding.

Compared with the above embodiment, the hollow plate 1 in the embodiment is provided with a plurality of crisscrossed grooves 12 only on one side wall. Through this structure, the crisscrossed grooves 12 on one side wall have a reinforcing effect on the wall surface. The grooves 12 deepen in an arc shape towards the inside of the cavity until they are connected together at the intersection of the other side wall to support the two side walls. The intersections of the grooves 12 between the many side walls are connected into a large number of support points to support the entire two wall surfaces, so that the grooves 12 on the two wall surfaces can be strengthened. The two wall surfaces are supported by many support points, and the internal hollow plate has light weight and high strength, which greatly saves materials and reduces manufacturing costs.

### Embodiment 3

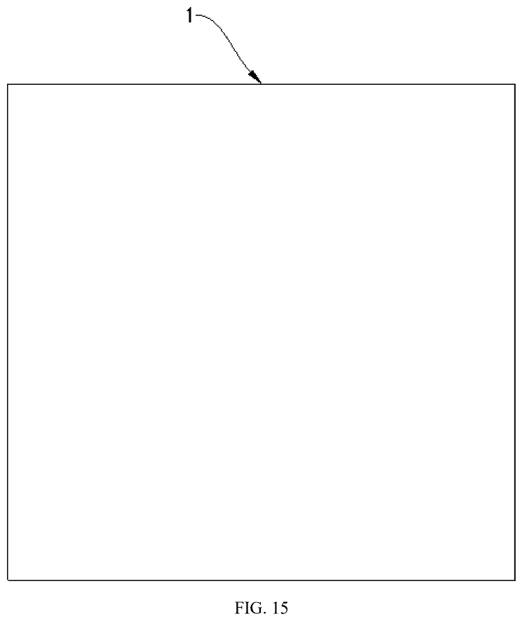

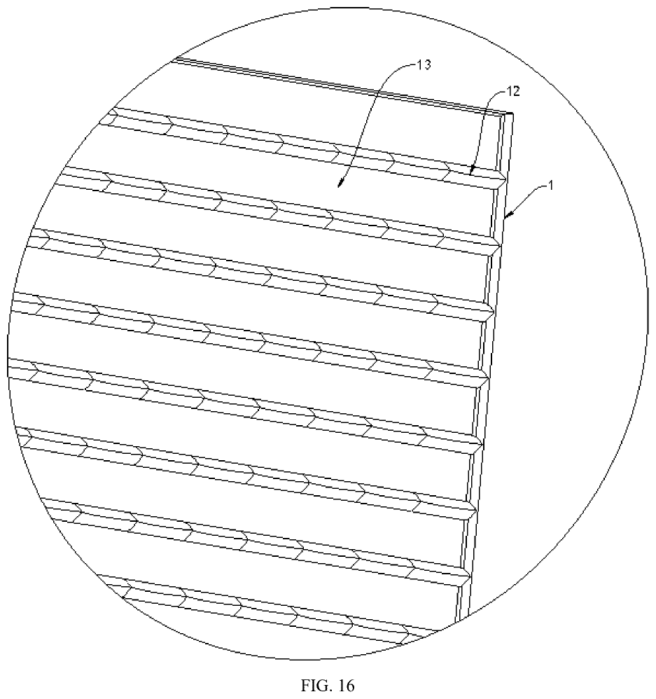

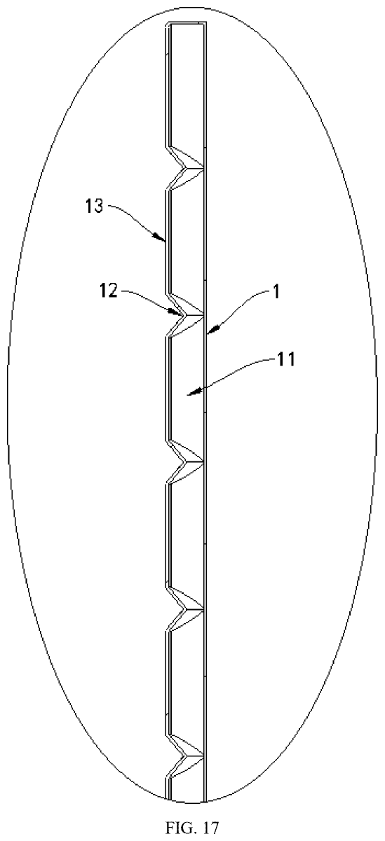

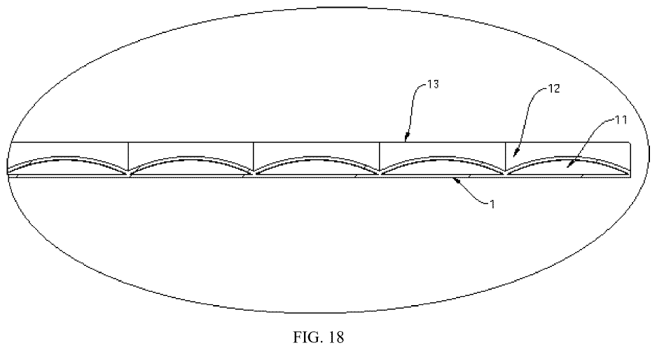

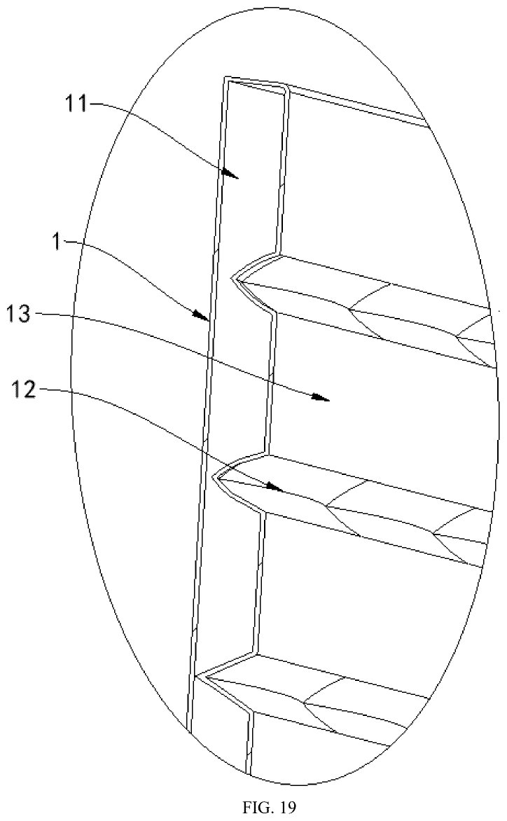

With reference to FIGS. 14-19, a double-layer hollow plate structure, comprising a hollow plate 1, wherein the hollow plate 1 is a double-layer wall structure and a cavity 11 is provided between the double-layer walls; one side wall of the hollow plate 1 is provided with a plurality of grooves 12, and the grooves 12 are divided into sections and each section deepens towards the inside of the cavity at both ends to form an arch shape.

As a specific technical solution of the embodiment, the intersection of the two sections of the grooves 12 is the deepest and is connected to the other side wall of the hollow plate 1 at the intersection.

In the embodiment, the groove 12 is arched in the depth direction, and this structure is just like the principle of an arch bridge. When the wall surface is impacted by external force, the arched groove 12 can transmit the external force to the support point, thereby achieving a good shock absorption effect. The two side walls are connected together at the intersection of the groove 12, which can play a role of support points of the two side walls. The intersections of the grooves 12 on the two side walls are connected into a large number of support points to support the entire two wall surfaces, thereby strengthening the support between the two side walls. This structural design strengthens the two side walls while ensuring that the internal hollow cavity is formed, which can meet the gas flow during blow molding and obtain good buffering performance. In this way, the required strength is achieved. This structure can further reduce the wall thickness, save materials, and reduce weight.

As a specific technical solution of the embodiment, the grooves 12 on one side wall of the hollow plate 1 may be distributed in a straight line, or in a broken line or a curved line.

As a specific technical solution of the embodiment, the grooves 12 are distributed in different shapes, so that the density and arrangement direction of the grooves 12 change to cope with different usage scenarios. For example, when the hollow plate 4 needs to be bent, a linear distribution groove 12 can be used; if better surface strength is required, it can be set to a broken line or curve distribution that is not easy to bend.

As a specific technical solution of the embodiment, the cross section of the groove 12 is V-shaped, U-shaped or arc-shaped, or a combination thereof.

As a specific technical solution of the embodiment, the plurality of grooves 12 divide one side wall of the hollow plate 1 into a plurality of unit areas 13.

In the embodiment, one side wall surface of the hollow plate 1 is provided with a plurality of grooves 12, and the grooves 12 divide the entire large area of the wall surface into a plurality of small units, thereby greatly increasing the wall surface strength. In this way, the wall thickness can be greatly reduced to achieve the required strength, thereby greatly reducing materials and weight, saving material and transportation costs. The hollow plate 1 is formed by blow molding or rotational molding, which is the same as the molding process of the above embodiment.

Compared with the above embodiments, the grooves 12 on one side wall of the hollow plate 1 in this embodiment are arranged longitudinally or transversely, and the grooves 12 distributed on one side wall have a reinforcing effect on the wall surface. The grooves 12 deepen in an arc shape toward the inside of the cavity 11 until they are connected together at the other side wall at the intersection, which can support the two side walls. The intersections of the plurality of grooves 12 between the two side walls are connected into numerous support points to support the entire two wall surfaces, so that the wall grooves 12 can be strengthened, and the numerous support points between the two wall surfaces support the hollow plate inside, which is light in weight and high in strength, greatly saving materials.

In summary, in the double-layer hollow plate structure, the crisscrossed grooves 12 have a reinforcing effect on the wall surface. The corresponding intersections of the grooves 12 on the inner and outer side walls of the hollow plate 1 are connected together, which can support the inner and outer walls. The intersections of many inner and outer wall grooves 12 are connected into many supporting points to support the entire two wall surfaces, which can be strengthened by the grooves 12 on the two wall surfaces. The two wall surfaces are supported by many supporting points. The internal hollow plate is light in weight and strong in strength, which greatly saves materials and has strong cushioning performance and strength. The wall thickness can be conveniently adjusted to adjust the cushioning performance and strength without re-opening the mold. It can replace foam board, pearl cotton board, honeycomb paperboard, and can also be used instead of corrugated paperboard. It has a recyclable function, improves economic benefits, and has broad application prospects.

It should be noted that, in this article, terms such as “comprises”, “includes” or any other variations thereof are intended to cover non-exclusive inclusion, so that a process, method, article or device including a series of elements includes not only those elements, but also includes other elements not explicitly listed, or also includes elements inherent to such process, method, article or device. In the absence of more restrictions, an element defined by the sentence “comprises a . . . ” does not exclude the existence of other identical elements in the process, method, article or device including the element.

Although the embodiments of the invention have been shown and described hereinabove, it can be understood that the above embodiments are exemplary and should not be understood as limiting the invention. Those of ordinary skill in the art can make changes, modifications, substitutions and variations to the above embodiments within the scope of the invention without departing from the principle and purpose of the invention.

1. A double-layer hollow plate structure, comprising a hollow plate, wherein the hollow plate is a double-layer wall structure and a cavity is provided between the double-layer walls; both side walls of the hollow plate are provided with a plurality of crisscrossed grooves, and the grooves deepen towards an inside of the cavity to form an arch shape.

2. The double-layer hollow plate structure of claim 1, wherein the positions of the grooves on both sides of the hollow plate correspond to each other.

3. The double-layer hollow plate structure of claim 1, wherein the plurality of crisscrossed grooves form a grid shape.

4. The double-layer hollow plate structure of claim 1, wherein the arch-shaped groove is recessed into the cavity to the deepest at the vertical and horizontal intersection point.

5. The double-layer hollow plate structure of claim 1, wherein the arch-shaped grooves on both sides of the hollow plate gradually deepen towards the vertical and horizontal intersection points and towards the inside of the cavity until they intersect and connect together at the vertical and horizontal intersection points.

6. The double-layer hollow plate structure of claim 1, wherein the crisscrossed grooves divide the two side walls of the hollow plate into a plurality of unit areas.

7. The double-layer hollow plate structure of claim 6, wherein the unit areas are in the shape of one of square, circle, triangle, rhombus, polygon, and line, or a combination of two or more.

8. The double-layer hollow plate structure of claim 1, wherein the depth of the arch-shaped groove recessed into the cavity is one of greater than zero, equal to zero, or less than zero.
